(19) United States
(12) Patent Application Publication
(10) Pub. No.: US 2014/0253854 A1
(43) Pub. Date: Sep. 11, 2014

(54) LIQUID CRYSTAL DISPLAY

(71) Applicant: Sony Corporation, Tokyo (JP)

(72) Inventors: Shinya Inage, Kumamoto (JP); Kazuki Abe, Kumamoto (JP); Yoichiro Nishida, Kumamoto (JP); Koudai Tokumasu, Kumamoto (JP)

(73) Assignee: Sony Corporation, Tokyo (JP)

(21) Appl. No.: 14/196,028

(22) Filed: Mar. 4, 2014

(30) Foreign Application Priority Data
Mar. 8, 2013 (JP) 2013-046374

(51) Int. Cl. G02F 1/1337

(52) U.S. Cl. CPC G02F 1/1337
USPC 349/125; 349/123

(57) ABSTRACT

A liquid crystal display includes: a drive substrate having a plurality of pixel electrodes at a pixel section as an effective pixel region; a counter substrate arranged in opposition to the drive substrate and having a counter electrode that is arranged in opposition to the plurality of pixel electrodes; a liquid crystal layer sealed between the drive substrate and the counter substrate; an alignment film formed at the pixel section and a part of or an entire peripheral section thereof on the surface at the liquid crystal layer side of the drive substrate; a protective film formed between the pixel electrode and the alignment film in at least the pixel section on the drive substrate; and a conductive film formed on the part of or the entire peripheral section of the drive substrate to come in contact with the alignment film.

### CROSS REFERENCE TO RELATED APPLICATIONS

This application claims the benefit of Japanese Priority Patent Application JP 2013-046374 filed on Mar. 8, 2013, the entire contents of which are incorporated herein by reference.

### BACKGROUND

The present disclosure relates to a liquid crystal display that controls the alignment of a liquid crystal layer using an alignment film.

For an LCD (Liquid Crystal Display), in a liquid crystal display panel, a liquid crystal layer is sealed between a drive substrate and a counter substrate, and an alignment film is formed on each opposite surface of the drive substrate and the counter substrate. On the drive substrate, therefore, the alignment film is formed on a pixel electrode, and the alignment film may include many defects (dangling bonds or vacancies) and the like inside the film that are caused due to a film-forming method thereof and the like. In other words, it is likely that the alignment film will be chemically activated, which may cause the pixel electrode to corrode in conjunction with the influence of auxiliary contributing factors such as moisture and electric current.

Accordingly, a method has been proposed that forms a protective film for prevention of corrosion as described above between a pixel electrode and an alignment film (for example, see Japanese Unexamined Patent Application Publication No. 2003-167255).

### SUMMARY

However, in the method disclosed in Japanese Unexamined Patent Application Publication No. 2003-167255, there is a disadvantage that an alignment film may come unstuck to have an influence on the display quality because the adhesiveness of the alignment film to the protective film is lower than that of the alignment film to the pixel electrode.

It is desirable to provide a liquid crystal display capable of maintaining the excellent display quality by suppressing the detachment of an alignment film.

According to an embodiment of the present disclosure, there is provided a liquid crystal display, including: a drive substrate having a plurality of pixel electrodes at a pixel section as an effective pixel region; a counter substrate arranged in opposition to the drive substrate and having a counter electrode that is arranged in opposition to the plurality of pixel electrodes; a liquid crystal layer sealed between the drive substrate and the counter substrate; an alignment film formed at the pixel section and a part of or an entire peripheral section thereof on the surface at the liquid crystal layer side of the drive substrate; a protective film formed between the pixel electrode and the alignment film in at least the pixel section on the drive substrate; and a conductive film formed on the part of or the entire peripheral section of the drive substrate to come in contact with the alignment film.

In the liquid crystal display according to the above-described embodiment of the present disclosure, the alignment film is formed over an area of the pixel section and a part of or the entire peripheral section thereof on the drive substrate, and the protective film is formed between the alignment film and the pixel electrode in at least the pixel section on the drive substrate. The conductive film that comes in contact with the alignment film is formed on a part of or the entire peripheral section of the drive substrate, which ensures that the adhesiveness of the alignment film to the drive substrate is maintained.

According to the liquid crystal display in the above-described embodiment of the present disclosure, the alignment film is formed over an area of the pixel section and a part of or the entire peripheral section thereof on the drive substrate, and the protective film is formed between the alignment film and the pixel electrode in at least the pixel section on the drive substrate. The conductive film that comes in contact with the alignment film is formed on a part of or the entire peripheral section of the drive substrate, which makes it possible to maintain the adhesiveness of the alignment film to the drive substrate. As a result, this allows the excellent display quality to be maintained by suppressing the detachment of the alignment film.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to explain the principles of the present technology.

FIG. 1 is a schematic block diagram showing an overall configuration of a liquid crystal display according to an embodiment of the present disclosure.

FIG. 2 is a schematic top view showing a configuration of a relevant part for a liquid crystal display panel illustrated in FIG. 1.

FIG. 3 is a schematic top view showing an arrangement example of bonding sections (dummy conductive film and aperture section).

FIG. 4 is an arrow cross-sectional view of a portion corresponding to I-I line illustrated in FIG. 3 in the liquid crystal display panel.

FIG. 5 is an arrow cross-sectional view of a portion corresponding to II-II line illustrated in FIG. 3 in the liquid crystal display panel.

FIG. 6 is a schematic diagram showing a detailed configuration example of the bonding sections illustrated in FIG. 3 and FIG. 5.

FIG. 7 is a cross-sectional view showing an enlarged view of the bonding sections illustrated in FIG. 3 and FIG. 5.

FIG. 8 is a schematic top view showing an arrangement example of a bonding section according to a modification example 1.

FIG. 9 is a schematic top view showing an arrangement example of a bonding section according to a modification example 2.

FIG. 10 is a schematic top view showing an arrangement example of a bonding section according to a modification example 3.

FIG. 11 is a cross-sectional view showing a configuration of a liquid crystal display panel according to a modification example 4.

### DETAILED DESCRIPTION

Hereinafter, some embodiments of the present disclosure are described in details with reference to the drawings. It is to be noted that the description is provided in the order given below.

1. Embodiment (an example of a liquid crystal display in which a plurality of bonding sections are provided at a region facing a signal line driving circuit)
2. Modification Example 1 (an example where a bonding section is provided at a region corresponding to four corners of an alignment film)
3. Modification Example 2 (an example where a bonding section is provided at a region corresponding to three sides of an alignment film)
4. Modification Example 3 (an example where a bonding section is provided at a region corresponding to four sides of an alignment film)
5. Modification Example 4 (an example where a protective film is selectively formed only at a pixel section)

### Embodiment

### Configuration

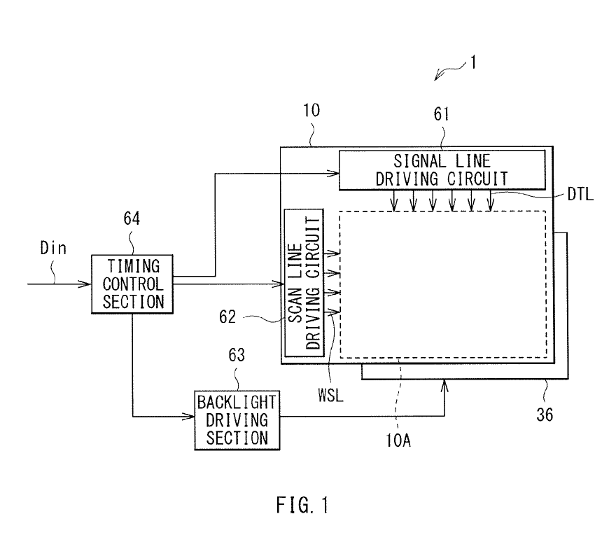

FIG. 1 shows an overall configuration of a liquid crystal display (liquid crystal display 1) according to an embodiment of the present disclosure. The liquid crystal display 1, which may include, for example, a liquid crystal display panel 10, a backlight 36, a backlight driving section 63, a timing control section 64, and the like, carries out an image display on the basis of an externally provided image signal Din. On the liquid crystal display panel 10, there may be formed, for example, a pixel section 10A as an effective pixel region and a peripheral circuit section (a signal line driving circuit 61 and a scan line driving circuit 62) for driving a display operation of the pixel section 10A. On the pixel section 10A, for example, a plurality of pixels (for example, R (red), G (green), and B (blue) sub-pixels) may be arranged in a matrix pattern. The peripheral circuit section including the signal line driving circuit 61, the scan line driving circuit 62, and the like is formed at a peripheral section (a peripheral section 10B) of the pixel section 10A on a drive substrate 11 to be hereinafter described.

The timing control section 64 controls a drive timing of the signal line driving circuit 61, the scan line driving circuit 62, and the backlight driving section 63, while providing the image signal Din to the signal line driving circuit 61. The scan line driving circuit 62 carries out a line-sequential drive of each pixel in accordance with a timing control that is performed by the timing control section 64. The signal line driving circuit 61 provides an image voltage based on the image signal Din provided from the timing control section 64 to each of the pixels. More specifically, the signal line driving circuit 61 generates an image signal in an analog signal formed by performing D/A (digital-to-analog) conversion for the image signal Din to output such a resultant signal to each of the pixels.

The backlight 36, which is a light source for irradiating light toward the liquid crystal display panel 10, may include, for example, a plurality of LEDs (Light-Emitting Diodes), CCFLs (Cold Cathode Fluorescent Lamps), and the like. The backlight 36 is driven by the backlight driving section 63, and a light turn-on state and a light turn-off state thereof are controlled.

### Liquid Crystal Display Panel 10

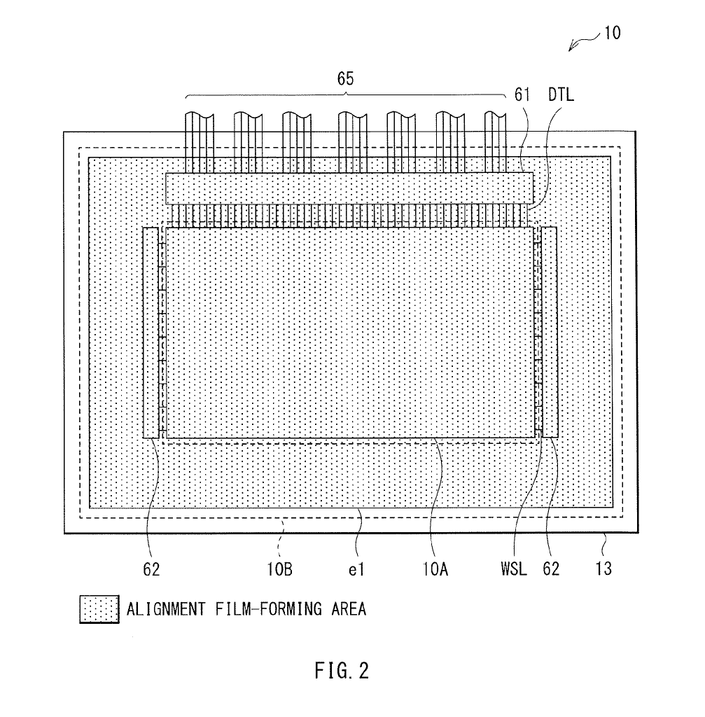

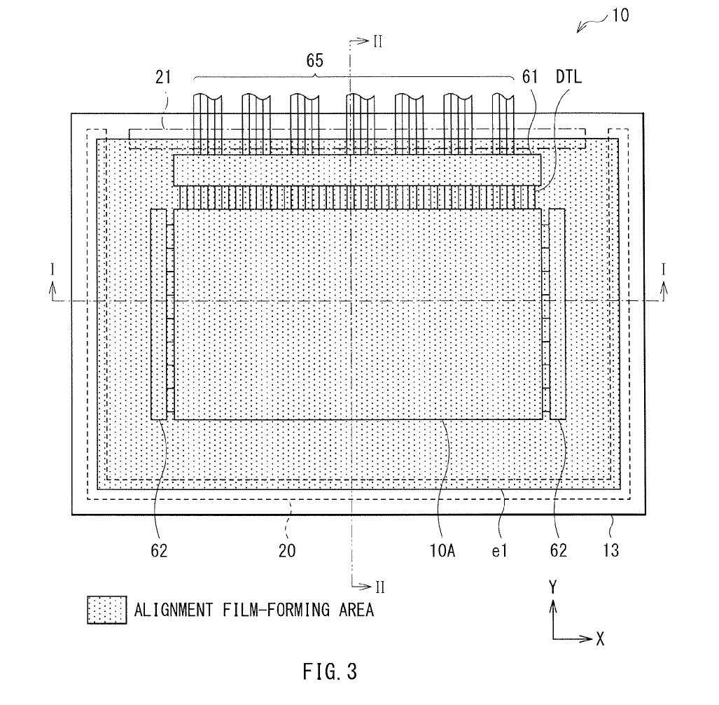

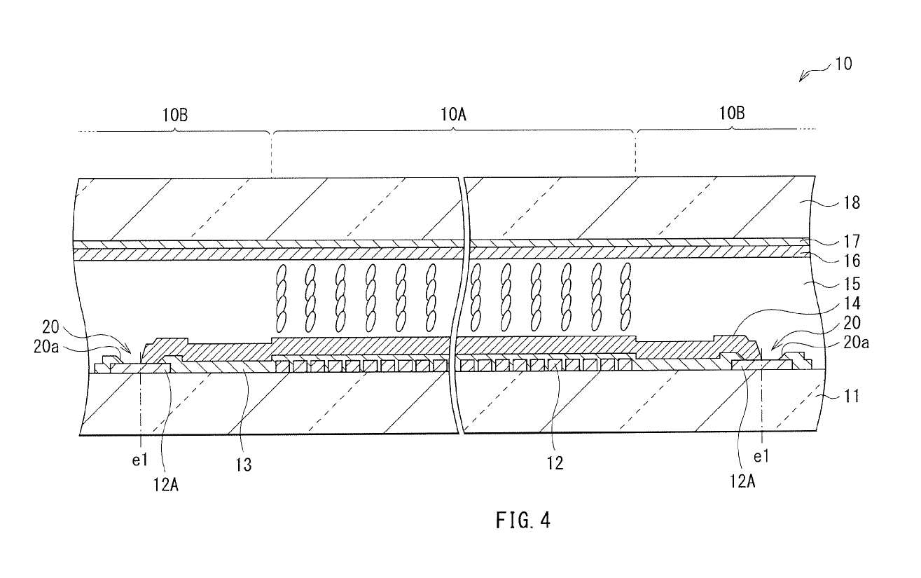

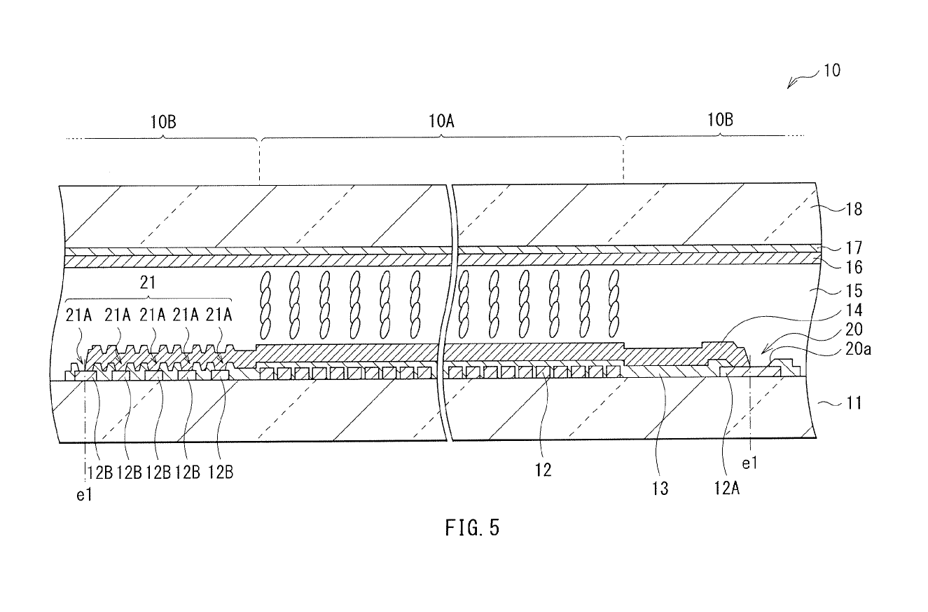

FIG. 2 shows a configuration of a relevant part for the liquid crystal display panel 10 (a planar arrangement example of a pixel section, a circuit section, an alignment film, and a protective film that are provided on a drive substrate). FIG. 3 shows a specific arrangement example (layout example) of bonding sections. FIG. 4 is an arrow cross-sectional view of a portion corresponding to I-I line illustrated in FIG. 3 in the liquid crystal display panel 10, and FIG. 5 is an arrow cross-sectional view of a portion corresponding to II-II line illustrated in FIG. 3 in the liquid crystal display panel 10.

The liquid crystal display panel 10 is configured in such a manner that a liquid crystal layer 15 is sealed between a drive substrate 11 and a counter substrate 18 that are arranged in opposition to one another. At the pixel section 10A on the drive substrate 11, a plurality of pixel electrodes 12 may be provided in a two-dimensional array form, for example. On the surface facing the pixel electrodes 12 of the counter substrate 18, there is provided a counter electrode 17. An alignment film 14 is formed on the surface at the liquid crystal layer 15 side of the drive substrate 11, and an alignment film 16 is formed on the surface at the liquid crystal layer 15 side (a surface of the counter electrode 17) of the counter substrate 18.

It is to be noted that a polarizing plate (not shown in the drawing) is bonded against each of the light incoming side of the drive substrate 11 and the light outgoing side of the counter substrate 18. Further, a seal layer is formed at a circumferential portion of the liquid crystal display panel 10, and the liquid crystal layer 15 is sealed between the drive substrate 11 and the counter substrate 18 using this seal layer.

The drive substrate 11, which may be made of, for example, a glass substrate, may have a rectangular planar shape (planar shape parallel to a display surface), for example. On the drive substrate 11, there are arranged the pixel section 10A and its peripheral section 10B, as well as a TFT (Thin-Film Transistor), a storage capacitor device (not shown in the drawing), wiring, and the like. At the pixel section 10A, each of the pixel electrodes 12 is connected with the above-described TFT, and an image voltage corresponding to the image signal Din is provided to each of the pixel electrodes 12 via this TFT.

The pixel electrode 12 is provided for each of the pixels, and may be configured of, for example, a transparent conductive film. As the transparent conductive film, an oxide semiconductor may be used that is called indium tin oxide (ITO), indium zinc oxide (IZO), zinc oxide (ZnO), or IGZO (Indium, Gallium, Zinc-containing Oxide), for example. In this embodiment of the present disclosure, the description is provided by taking as an example the ITO from among the above-described transparent conductive film materials, although a constituent material for the pixel electrode 12 is not limited to the ITO. However, as described later, when a conductive film material capable of producing a reductive reaction to the alignment film 14 (for example, an inorganic alignment film made of SiO₂) is used, the advantageous effects of the present disclosure are valid.

The counter substrate 18 may be configured of, for example, a glass substrate. On the counter substrate 18, there may be provided, for example, a color filter and a light-shielding layer (black matrix layer) (both of them are not shown in the figure), and these may be covered with, for example, an overcoating film. On this overcoating film, there are provided the counter electrode 17.

The counter electrode 17, which may be, for example, an electrode in common to each of the pixels, provides an image voltage to the liquid crystal layer 15 together with the pixel electrode 12. As with the above-described pixel electrode 12, the counter electrode 17 may be configured of, for example, the transparent conductive film as described above.

The liquid crystal layer 15 has a functionality to control the transmittance of light that is transmitted therethrough depending on an image voltage provided through the pixel electrode 12 and the counter electrode 17. The liquid crystal layer 15 may contain a liquid crystal material that is driven for a display operation using, for example, VA (Vertical Alignment) mode, TN (Twisted Nematic) mode, ECB (Electrically Controlled Birefringence) mode, FFS (Fringe Field Switching) mode, or IPS (In-Plane Switching) mode, and the like. As described above, the liquid crystal material for the liquid crystal layer 15 is not limited specifically, although especially when an alignment control is carried out using an inorganic alignment film like the alignment films 14 and 16 to be described hereinafter, the above-described material is useful.

Each of the alignment films 14 and 16, which is intended to perform an alignment control of the liquid crystal layer 15, may be configured of an inorganic alignment film made of, for example, a material such as silicon oxide (SiO₂). Each of the alignment films 14 and 16 may have a thickness within a range of about 120 to 360 nm, for example. Each of the alignment films 14 and 16 is formed using, for example, an evaporation method. Further, as shown in FIG. 2 and FIG. 4, the alignment film 14 is formed to cover the pixel electrodes 12 over an area from the pixel section 10A to the peripheral section 10B. In other words, the alignment film 14 has an end edge e1 at the peripheral section 10B. Additionally, a planar shape of a film-forming region of the alignment film 14 may be rectangular substantially the same as a planar shape of the drive substrate 11, for example. It is to be noted that the same is true for the alignment film 16. On the drive substrate 11, however, a protective film 13 is formed between the pixel electrode 12 and the alignment film 14 in at least the pixel section 10A.

The protective film 13 is formed to suppress corrosion of the pixel electrode 12. The protective film 13 may be an inorganic film that is more chemically-stabilized than the alignment film 14, such as a silicon oxide film or a silicon nitride (SiN) film with a thickness within a range of about 30 to 70 nm, for example. The protective film 13, which is formed to cover at least the pixel section 10A, may be deposited using a more chemically-stabilized method than an evaporation method, such as a CVD (Chemical Vapor Deposition) method or a sputtering method. Here, it is likely that the alignment film 14 will cause a defect (dangling bonds or vacancies) and the like inside the film due to an inorganic film that is formed in the evaporation method as described above, and further a compositional ratio of Si to O may be not constant as well in many cases. Therefore, the alignment film 14 is easily chemically-activated, and when the alignment film 14 and the pixel electrode 12 come in contact with one another, the pixel electrode 12 (for example, ITO) may corrode due to reduction and the like of the alignment film 14 (for example, SiO₂). The corrosion of the pixel electrode 12 as described above is suppressed by forming the protective film 13 that is more chemically-stabilized than the alignment film 14 between the alignment film 14 and the pixel electrode 12. In this embodiment of the present disclosure, the protective film 13 may be formed at a region surrounding the end edge e1 of the alignment film 14 (for example, over a whole surface of the drive substrate 11) over an area from the pixel section 10A to the peripheral section 10B, for example.

### Bonding Sections 20 and 21

In this embodiment of the present disclosure, a conductive film (a dummy conductive film 12A) that comes in contact with the alignment film 14 is provided in a part of or the entire peripheral section 10B on the drive substrate 11 as described above. As mentioned previously, the protective film 13 is formed over an area from the pixel section 10A to the peripheral section 10B on the drive substrate 11, and the protective film 13 has an aperture portion (an aperture section 20a) at a region facing the dummy conductive film 12A. The alignment film 14 comes in contact with the dummy conductive film 12A via the aperture section 20a (at the aperture section 20a) in the peripheral section 10B. It is to be noted that the dummy conductive film 12A corresponds to a specific but not limitative example of a “conductive film” in one embodiment of the present disclosure. Hereinafter, the description is provided in such a manner that a section configured of the dummy conductive film 12A and the aperture section 20a is termed a bonding section (bonding sections 20 and 21).

The dummy conductive film 12A is a conductive film for bonding the alignment film 14 to the drive substrate 11, and may be configured of, for example, a transparent conductive film similar to the pixel electrode 12. However, the dummy conductive film 12A may be alternatively a conductive film that functions as a part of a wiring layer that is provided on the drive substrate 11. More specifically, the bonding sections 20 and 21 may be formed utilizing a part of the wiring layer that is provided beforehand on the drive substrate 11. A constituent material for the dummy conductive film 12A is not limited specifically provided that such a material has the higher adhesiveness to the alignment film 14 than the protective film 13. Here, the dummy conductive film 12A may be configured of, for example, the same transparent conductive film (for example, ITO) as the pixel electrode 12. This is because it is possible to carry out a film formation and a patterning treatment for the dummy conductive films 12A and the pixel electrodes 12 as a batch process (in the same process). In this embodiment of the present disclosure, there are provided the plurality of dummy conductive films 12A, and each of the dummy conductive films 12A configures the bonding section 20 or the bonding section 21 (more specifically, a bonding section 21A to be hereinafter described).

The aperture section 20a is formed at a predetermined region of the protective film 13 (a region facing the dummy conductive film 12A) by means of an etching using, for example, a photolithographic approach. The aperture section 20a is arranged in opposition to the dummy conductive film 12A, and has a smaller aperture shape than a planar shape of the dummy conductive film 12A. For example, the aperture section 20a may be provided on a one-to-one basis corresponding to the dummy conductive film 12A, and may have a slightly smaller aperture shape than a planar shape of the dummy conductive film 12A. However, the aperture section 20a and the dummy conductive film 12A are not necessarily provided on a one-to-one basis, but the plurality of aperture sections 20a may be alternatively provided with respect to a single dummy conductive film 12A. Further, a position, a shape, a size, the number of pieces, and the like for the aperture section 20a are not limited specifically, although they may be preferably designed to assure as large a contact area of the alignment film 14 and the dummy conductive film 12A as possible in terms of the increased adhesiveness of the alignment film 14. Additionally, as described later, the aperture section 20a and the dummy conductive film 12A may be preferably designed in accordance with circuits and wiring patterns on the drive substrate 11, and further may be preferably formed along the end edge e1 of the alignment film 14. Hereinafter, the description is provided on a detailed configuration of the bonding sections 20 and 21 that are configured of the dummy conductive film 12A and the aperture section 20a.

For example, as shown in FIG. 3, the bonding sections 20 and 21 are formed at a region corresponding to each side of a rectangular film-forming region of the alignment film 14. Here, as mentioned previously, a circuit section that is configured of the signal line driving circuit 61, the scan line driving circuit 62, and the like is arranged at the peripheral section 10B on the drive substrate 11. The bonding section 21 is formed at a region (first region) in which the signal line driving circuit 61 or wiring to be connected therewith (wires 65 or signal lines DTL) is provided, and the bonding section 20 is formed at a region (second region) other than the above-described region at the peripheral section 10B. The bonding section 21 of these two bonding sections is configured of a plurality of bonding sections 21A to be hereinafter detailed.

First, the description is provided on the bonding section 20 with reference to FIG. 3 and FIG. 4. For example, the bonding section 20 may be formed at a region (U-shaped region) along each of three rectangular sides of the alignment film 14 in a line (continuously) along the end edge e1 of the alignment film 14. More specifically, in the bonding section 20, the dummy conductive film 12A may be closely formed, for example, along the end edge e1 of the alignment film 14, and the aperture section 20a may form a slit (groove) with, for example, a predetermined width (for example, in the order of several hundred micrometers) on the dummy conductive film 12A. The bonding section 20 may be preferably formed at a region including three rectangular sides and four corners (corner portions) of the alignment film 14. This is because it is likely that the detachment of the alignment film 14 will occur especially from four corners as a point of origin in the rectangular shape.

In the bonding section 20, the end edge e1 of the alignment film 14 comes in contact with the dummy conductive film 12A at the aperture section 20a, that is, the alignment film 14 is bonded with the drive substrate 11 at the end edge e1. However, the configuration of the bonding section 20 is not limited thereto, but for example, the bonding section 20 may be formed at a region between the end edge e1 of the alignment film 14 and the pixel region 10A, and the alignment film 14 may be bonded with the drive substrate 11 at an inner part from the end edge e1 (a portion closer to the pixel section 10A). More specifically, for the alignment film 14, the end edge e1 does not necessarily come in contact with the dummy conductive film 12A, and a part of or the entire peripheral section 10B may come in contact with the dummy conductive film 12A.

Next, the description is provided on the bonding section 21 with reference to FIG. 3 and FIG. 5. The bonding section 21 may be formed at a region corresponding to one rectangular side of the alignment film 14, for example. Here, at a part of the peripheral section 10B on the drive substrate 11, there are provided the signal line driving circuit 61, as well as lead wires (wiring 65) to be connected with, for example, an FPC (Flexible Printed Circuit Board), and the like, and various circuits and wires are populated in high density. More specifically, in the vicinity of the signal line driving circuit 61, various wires are formed to intersect with each other, and complicated wiring patterns are formed.

Accordingly, at a region in the vicinity of the signal line driving circuit 61 as described above in the peripheral section 10B on the drive substrate 11, a plurality of bonding sections 21A are formed as the bonding section 21 depending on wiring patterns as described above (the bonding section 21 is divided into segments). It is to be noted that, in FIG. 3, a planar shape of the overall bonding section 21 is only shown, and the segmented bonding section 21 is not shown for simplicity.

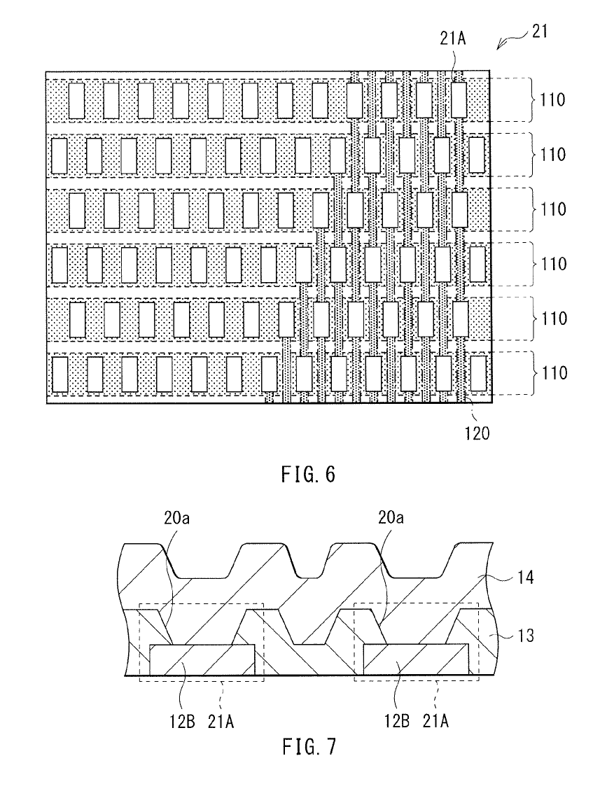

FIG. 6 shows a detailed configuration example of the bonding section 21 along with an example of the wiring pattern. FIG. 7 enlarges a cross-sectional configuration in the vicinity of each of the bonding sections 21A. As shown in FIG. 6, in the bonding section 21, the plurality of bonding sections 21A are arranged discretely (each of the bonding sections 21A is formed in the island-like pattern). In other words, in the bonding section 21, the plurality of dummy conductive films 12A are arranged apart from each other two-dimensionally, and each of the aperture sections 20a forms a pore with, for example, a predetermined width (for example, in the order of several dozen of micrometers) on each of the dummy conductive films 12A. More specifically, the drive substrate 11 is provided with the wiring patterns (for example, a plurality of wires 110 and 120 that intersect with one another), and the bonding sections 21A are formed for such wiring patterns without spanning a region between the wires 110, a region between the wires 120, or a region between the wire 110 and the wire 120, for example. This results in conduction between the wires 110, between the wires 120, or between the wire 110 and the wire 120 in the bonding section 21 by virtue of provision of the dummy conductive films 12A, which makes it possible to suppress occurrence (or an increase) of parasitic capacitance.

In the bonding section 21, the dummy conductive film 12A and the alignment film 14 come in contact with one another with the aperture section 20a in between in each of the bonding sections 21A, which assures the adhesiveness of the alignment film 14. In such a manner, in this embodiment of the present disclosure, at a region where the signal line driving circuit 61 or wiring (65, DTL) to be connected therewith is formed, the plurality of bonding sections 21A (that is, the dummy conductive films 12A) are arranged discretely. This makes it possible to suppress occurrence of parasitic capacitance and the like in the wiring patterns, while assuring the contact area of the alignment film 14 and the dummy conductive film 12A for increased adhesiveness.

### Function and Advantageous Effects

In the liquid crystal display 1, as shown in FIG. 1, when the image signal Din is input to the timing control section 64, the scan line driving circuit 62 and the signal line driving circuit 61 drive each of the pixels on the pixel section 10A to perform a display operation. In concrete terms, in accordance with a control of the timing control section 64, the scan line driving circuit 62 provides scan signals sequentially to a scan line WSL that is connected with each pixel, while the signal line driving circuit 61 provides an image signal based on the image signal Din to a predetermined signal line DTL. This selects a pixel located at a point of intersection between the signal line DTL to which the image signal is provided and the scan line WSL to which the scan signal is provided to apply an image voltage to the selected pixel.

In the pixel selected in such a manner, an image voltage is provided through the pixel electrode 12 and the counter electrode 17, and accordingly alignment status of liquid crystal molecules in the liquid crystal layer 15 may vary depending on a magnitude of the image voltage. As a result, this varies the optical characteristics in the liquid crystal layer 15, and light incoming into the liquid crystal layer 15 from the backlight 36 is modulated on each pixel basis to be emitted out onto the counter substrate 18. In the liquid crystal display 1, images are displayed in such a manner.

Here, in this embodiment of the present disclosure, on the drive substrate 11, the protective film 13 (for example, an inorganic film that is formed using the CVD method) is formed between the pixel electrode 12 and the alignment film 14 (for example, an inorganic alignment film that is formed using the evaporation method) to suppress corrosion of the pixel electrode 12. However, the alignment film 14 has the low adhesiveness to such a protective film 13.

Accordingly, in this embodiment of the present disclosure, the dummy conductive film 12A that comes in contact with the alignment film 14 is provided in a part of or the entire peripheral section 10B on the drive substrate 11. In concrete terms, the protective film 13 that is formed over an area from the pixel section 10A to the peripheral section 10B has the aperture section 20a at a predetermined region (a region facing the dummy conductive film 12A) on the peripheral section 10B. The alignment film 14 and the dummy conductive film 12A come in contact with one another with the aperture section 20a in between. This ensures that the adhesiveness of the alignment film 14 to the drive substrate 11 is maintained. Here, in the alignment film 14, a stress is generated due to volume variation that is caused by moisture absorption or thermal stress, and such a stress may cause detachment of the alignment film 14 out of the drive substrate 11 or cracking in the alignment film 14. When such a detachment of the alignment film 14 and any other defect reach the pixel section 10A, it is likely that the alignment of the liquid crystal layer 15 is disturbed to cause a display defect in the liquid crystal display panel 10. Further, there is a possibility that such a phenomenon will make progress not only during formation of the panel but also during use of the panel. Provision of the dummy conductive film 12A and the aperture section 20a as described above ensures that the adhesiveness between the alignment film 14 and the drive substrate 11 is maintained, and the detachment of the alignment film 14 and the like are suppressed.

Further, in this embodiment of the present disclosure, at a region where the signal line driving circuit 61 and wiring (65, DTL) to be connected therewith are provided, the plurality of bonding sections 21A (dummy conductive films 12A and the aperture sections 20a) are arranged discretely in the bonding section 21. This makes it possible to increase the adhesiveness, while suppressing occurrence of parasitic capacitance in the wiring patterns, and the like. If the parasitic capacitance occurs in the vicinity of the signal line driving circuit 61, wiring potential of the signal line DTL and the like might vary to have an influence on the display image quality. However, in this embodiment of the present disclosure, a discrete arrangement of the bonding sections 21A makes it possible to suppress deterioration in the display image quality due to occurrence of such a parasitic capacitance.

Additionally, in this embodiment of the present disclosure, at a region other than the vicinity of the signal line driving circuit 61 as described above, the bonding section 20 has the U-shaped planar form including a region corresponding to three sides and four corners of the alignment film 14. Here, the scan line driving circuit 62 may be formed, for example, at a region corresponding to two facing rectangular sides of the alignment film 14. In the vicinity of the scan line driving circuit 62, it is less likely that circuits and wires will be populated in high density as compared with the vicinity of the signal line driving circuit 61. Therefore, it is less likely that the arrangement (layout) of the bonding section 20 will be subject to the restriction. This makes it possible to form the bonding section 20 along the end edge e1 at a region corresponding to three sides and four corners of the alignment film 14, which allows the adhesiveness to be fully assured.

As described thus far, in this embodiment of the present disclosure, the alignment film 14 is provided over an area of the pixel section 10A and a part of or the entire peripheral section 10B on the drive substrate 11, and the protective film 13 is provided between the alignment film 14 and the pixel electrode 12. Since the dummy conductive film 12A that comes in contact with the alignment film 14 is provided in a part of or the entire peripheral section 10B on the drive substrate 11, it is possible to maintain the adhesiveness of the alignment film 14 to the drive substrate 11. This makes it possible to maintain the excellent display quality by suppressing the detachment of the alignment film 14.

Moreover, because the adhesiveness of the alignment film 14 is maintained, for example, the initial yield of the image quality is increased, and this contributes to an increase in a lifetime of the liquid crystal display panel 10.

Hereinafter, the description is provided on modification examples (modification examples 1 to 4) of the bonding section according to the above-described embodiment of the present disclosure. In the above-described embodiment of the present disclosure, a case where the bonding sections 20 and 21 that are configured of the dummy conductive films 12A and the aperture sections 20a are arranged on the drive substrate 11 depending on the wiring patterns of the drive substrate 11 is illustrated by an example, although any of the arrangement configurations as described in the following modification examples 1 to 4 may be permitted alternatively. It is to be noted that any component parts essentially same as those in the above-described embodiment are denoted with the same reference numerals, and the related descriptions are omitted as appropriate.

### Modification Example 1

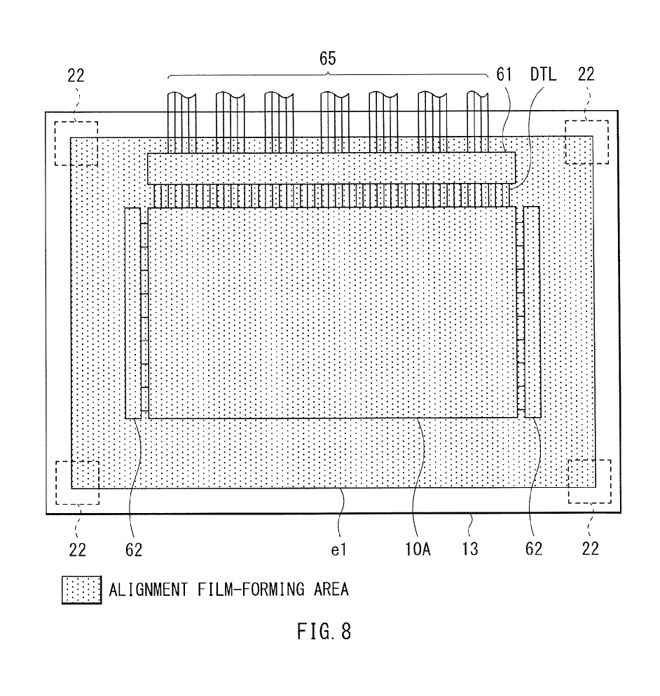

FIG. 8 shows an arrangement example of a bonding section (bonding section 22) according to a modification example 1. In this modification example, each of the bonding sections 22 is formed at a region corresponding to four corners of a rectangular film-forming region of the alignment film 14. As with the above-described embodiment of the present disclosure, each of the bonding sections 22 is configured of the dummy conductive film 12A and the aperture section 20a that is provided on the protective film 13, and the dummy conductive film 12A and the alignment film 14 come in contact with one another with the aperture section 20a in between (the dummy conductive film 12A and the aperture section 20a are not shown in FIG. 8).

As described in the above-described embodiment of the present disclosure, the alignment film 14 may come unstuck due to a stress that is caused by the moisture absorption and the like, and it is likely that four corners of the alignment film 14 will become a point of origin of the detachment because such a stress concentrates on four corners (corner portions) especially where the continuity of the film is interrupted. Like this modification example, by forming each of the bonding sections 22 selectively at regions corresponding to four corners of the alignment film 14, it is possible to efficiently suppress the detachment of the alignment film 14 using the minimized bonding area. This is useful in a case where the arrangement of the bonding section 22 is significantly subject to the restriction, such as a case where the wiring density of the peripheral section 10B is also high at a region other than the vicinity of the signal line driving circuit, and a case where a narrow framing is necessary.

### Modification Example 2

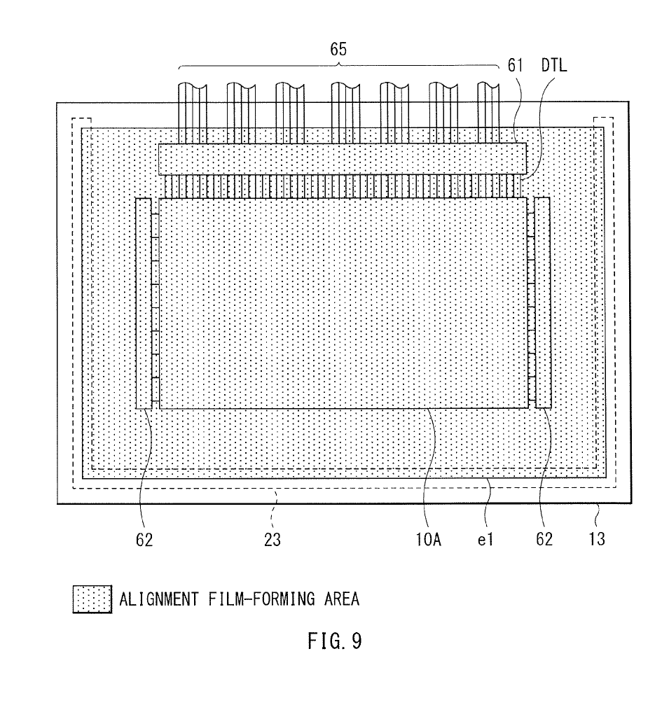

FIG. 9 shows an arrangement example of a bonding section (bonding section 23) according to a modification example 2. In this modification example, the bonding section 23 is formed at a region corresponding to three sides and four corners (a region excluding a region corresponding to the signal line driving circuit 61) in a rectangular film-forming region of the alignment film 14. As with the bonding section 20 according to the above-described embodiment of the present disclosure, the bonding section 23 is formed along the end edge e1 of the alignment film 14 at a U-shaped region. Further, each of the bonding sections 23 is configured of the dummy conductive film 12A and the aperture section 20a that is provided on the protective film 13, and the dummy conductive film 12A and the alignment film 14 come in contact with one another with the aperture section 20a in between (the dummy conductive film 12A and the aperture section 20a are not shown in FIG. 9).

As described in the above-described embodiment of the present disclosure, on the drive substrate 11, circuits and the like are populated in high density in the vicinity of the signal line driving circuit 61. Like this modification example, by forming each of the bonding sections 23 selectively at a region corresponding to three sides and four corners excluding the vicinity of the signal line driving circuit 61, it is possible to efficiently suppress the detachment of the alignment film 14 while suppressing occurrence of parasitic capacitance through a simpler arrangement as compared with the above-described embodiment of the present disclosure.

### Modification Example 3

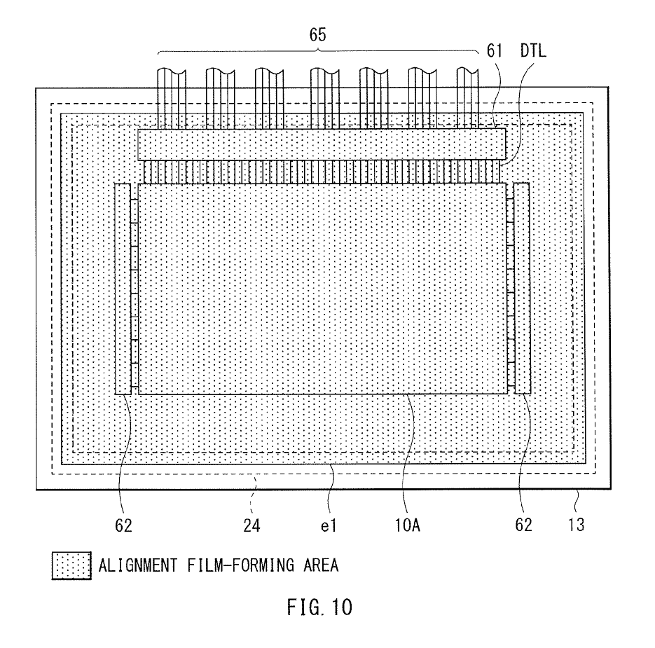

FIG. 10 shows an arrangement example of a bonding section (bonding section 24) according to a modification example 3. In this modification example, the bonding section 24 is formed at a region corresponding to four sides in a rectangular film-forming region of the alignment film 14. The bonding section 24 is formed along the end edge e1 of the alignment film 14 to surround a rectangular shape of the alignment film 14. Further, the bonding section 24 is configured of the dummy conductive film 12A and the aperture section 20a that is provided on the protective film 13, and the dummy conductive film 12A and the alignment film 14 come in contact with one another with the aperture section 20a in between (the dummy conductive film 12A and the aperture section 20a are not shown in FIG. 10).

Like this modification example, the bonding section 24 may be formed at a region corresponding to four sides of the alignment film 14, and also in such a case, it is possible to obtain the substantially the same effects as with the above-described embodiment and the like.

### Modification Example 4

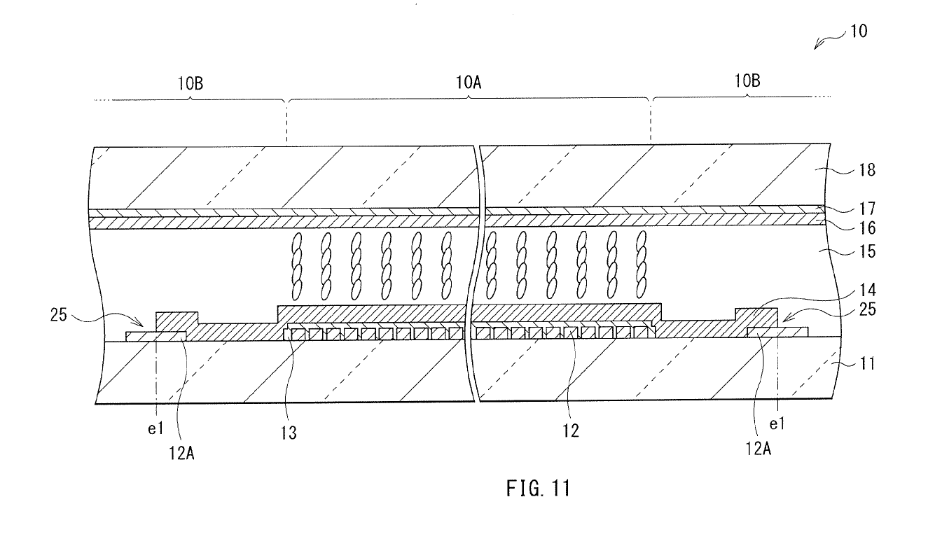

FIG. 11 shows a cross-sectional configuration of the liquid crystal display panel including a bonding section (bonding section 25) according to a modification example 4. In the above-described embodiment and the like, the description is provided on a case where the protective film 13 is formed over an area from the pixel section 10A to the peripheral section 10B, and the alignment film 14 comes in contact with the dummy conductive film 12A with the aperture section 20a that is provided at the peripheral section 10B of the protective film 13 in between. In such a manner, in forming the aperture section 20a by etching only a selective region facing the dummy conductive film 12A of the protective film 13, it is easy to determine an etching selection ratio of the dummy conductive film 12A (for example, ITO) and the protective film 13 (for example, SiO₂ and the like), resulting in the patterning being performed with ease relatively. As seen above, the bonding sections according to the above-described embodiment are excellent in terms of the easiness of the process, although the protective film 13 is not necessarily formed at the peripheral section 10B.

For example, like this modification example, the protective film 13 may be formed only at the pixel section 10A (a portion corresponding to the peripheral section 10B may be removed). As a result, at the peripheral section 10B, a whole surface (more specifically, top surface and side surface) of the dummy conductive film 12A (bonding section 25) is exposed from the protective film 13, and a partial or whole surface (a partial surface in this example) of the dummy conductive film 12A is covered with the alignment film 14. This ensures that the alignment film 14 is bonded with the drive substrate 11. In this case, to begin with, the protective film 13 may be formed over a whole surface of the drive substrate 11, and subsequently a portion corresponding to the peripheral section 10B may be removed selectively by means of an etching by the use of the photolithographic approach, for example. On this occasion, it is possible to selectively remove only the protective film 13 that is formed at the peripheral section 10B by optimizing etching requirements to determine the etching selection ratio between the surface of the drive substrate 11 and the protective film 13, or by using the anisotropic etching and the like.

In this modification example, this makes it possible to obtain the substantially the same effects as with the above-described embodiment of the present disclosure. Further, as compared with a case where the dummy conductive film 12A and the alignment film 14 come in contact with one another with the aperture section 20a in between, it is easier to assure the area in contact with the dummy conductive film 12A. This allows the adhesiveness to be further increased.

The present disclosure is described thus far with reference to some embodiments and modification examples, although the present disclosure is not limited to the above-described embodiments and the like, but different variations are available. For example, in the above-described embodiment and the like, a case where a film-forming region of the alignment film 14 takes the rectangular shape is illustrated by an example, although the present disclosure is applicable to any alignment film in the form other than the rectangular shape. For example, the alignment film may take the square shape and the like, and this is useful especially when the alignment film has a shape including corner portions.

Further, the arrangement, planar shape and the like of the conductive film and the aperture section according to this embodiment are not limited to each of the arrangement, planar shape and the like of the bonding sections 20 and 21 (dummy conductive films 12A and the aperture sections 20a) that are described in the above-described embodiment and the like. As a matter of course, it is possible to take various forms depending on a planar shape of the drive substrate 11, a film-forming region of the alignment film 14, wiring patterns, a degree of freedom in arrangement of the conductive film, and the like.

Additionally, in the above-described embodiment and the like, the dummy conductive film and the aperture section are provided as bonding sections for attaching the drive substrate 11 and the alignment film 14, although the similar configuration is also applicable to the counter substrate 18. In other words, when a protective film for suppressing corrosion of the counter electrode 17 is formed between the counter electrode 17 and the alignment film 16, as with the drive substrate 11, also on the counter substrate 18, the detachment of the alignment film 16 may be an issue of concern. Therefore, on the counter substrate 18 as well, it is possible to bring the alignment film 16 into contact with the dummy conductive film with the aperture section in between by providing the dummy conductive film at the peripheral section 10B and by providing the aperture section at a region facing the dummy conductive film on the protective film. In such a manner, the present disclosure is not limited to the drive substrate 11, but is also applicable to the counter substrate 18.

It is possible to achieve at least the following configurations from the above-described example embodiments of the disclosure.

(1) A liquid crystal display, including:

a drive substrate having a plurality of pixel electrodes at a pixel section as an effective pixel region;

a counter substrate arranged in opposition to the drive substrate and having a counter electrode that is arranged in opposition to the plurality of pixel electrodes;

a liquid crystal layer sealed between the drive substrate and the counter substrate;

an alignment film formed at the pixel section and a part of or an entire peripheral section thereof on the surface at the liquid crystal layer side of the drive substrate;

a protective film formed between the pixel electrode and the alignment film in at least the pixel section on the drive substrate; and

a conductive film formed on the part of or the entire peripheral section of the drive substrate to come in contact with the alignment film.

(2) The liquid crystal display according to (1), wherein the protective film is formed over an area of the pixel section and a part of or the entire the peripheral section on the drive substrate, and has an aperture section at a region facing the conductive film at the peripheral section, and

the alignment film and the conductive film come in contact with one another at the aperture section.

(3) The liquid crystal display according to (2), wherein an end edge of the alignment film comes in contact with the conductive film at the aperture section.
(4) The liquid crystal display according to (2) or (3), wherein the plurality of conductive films are provided at the peripheral section, and the aperture section is provided in opposition to each of the plurality of conductive films.
(5) The liquid crystal display according to any one of (1) to (4), wherein the drive substrate has a signal line driving circuit that is configured to provide an image signal to the pixel section at the peripheral section, and

two or more of the plurality of conductive films are arranged discretely at a first region having the signal line driving circuit or wiring that is connected with the signal line driving circuit on the peripheral section.

(6) The liquid crystal display according to (5), wherein other conductive films among the plurality of conductive films are provided along an end edge of the alignment film at another second region of the peripheral section.
(7) The liquid crystal display according to (6), wherein a planar shape of the alignment film is rectangular, and

the first region is a region corresponding to one side of the rectangular form, while the second region is a region corresponding to three sides and four corners of the rectangular form.

(8) The liquid crystal display according to any one of (4) to (7), wherein a planar shape of the alignment film is rectangular, and

the plurality of conductive films are provided at regions corresponding to four corners of the rectangular form.

(9) The liquid crystal display according to any one of (4) to (8), wherein the plurality of conductive films are provided at a region corresponding to four corners and three sides of the rectangular form.
(10) The liquid crystal display according to (3), wherein a planar shape of the alignment film is rectangular, and

the conductive film is provided along an end edge of the alignment film at a region corresponding to four sides of the rectangular form.

(11) The liquid crystal display according to (1), wherein the protective film is selectively formed at the pixel section on the drive substrate.
(12) The liquid crystal display according to any one of (1) to (11), wherein the alignment film is an inorganic alignment film, and

the protective film is an inorganic film that is more chemically-stabilized than the alignment film.

(13) The liquid crystal display according to any one of (1) to (12), wherein the alignment film is formed in an evaporation method, and the protective film is formed in a chemical vapor deposition method.
(14) The liquid crystal display according to any one of (1) to (13), wherein the alignment film is a silicon oxide film, and the protective film is a silicon oxide film or a silicon nitride film.
(15) The liquid crystal display according to any one of (1) to (14), wherein the conductive film is configured of the same transparent conductive film as the pixel electrode.
(16) The liquid crystal display according to any one of (1) to (15), wherein the pixel electrode and the conductive film are configured of indium tin oxide.
(17) The liquid crystal display according to any one of (1) to (16), wherein the conductive film functions as a part of a wiring layer that is provided on the drive substrate.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display, comprising:
a drive substrate having a plurality of pixel electrodes at a pixel section as an effective pixel region;
a counter substrate arranged in opposition to the drive substrate and having a counter electrode that is arranged in opposition to the plurality of pixel electrodes;
a liquid crystal layer sealed between the drive substrate and the counter substrate;
an alignment film formed at the pixel section and a part of or an entire peripheral section thereof on the surface at the liquid crystal layer side of the drive substrate;
a protective film formed between the pixel electrode and the alignment film in at least the pixel section on the drive substrate; and
a conductive film formed on the part of or the entire peripheral section of the drive substrate to come in contact with the alignment film.

2. The liquid crystal display according to claim 1, wherein the protective film is formed over an area of the pixel section and a part of or the entire the peripheral section on the drive substrate, and has an aperture section at a region facing the conductive film at the peripheral section, and
the alignment film and the conductive film come in contact with one another at the aperture section.

3. The liquid crystal display according to claim 2, wherein an end edge of the alignment film comes in contact with the conductive film at the aperture section.

4. The liquid crystal display according to claim 2, wherein the plurality of conductive films are provided at the peripheral section, and the aperture section is provided in opposition to each of the plurality of conductive films.

5. The liquid crystal display according to claim 4, wherein the drive substrate has a signal line driving circuit that is configured to provide an image signal to the pixel section at the peripheral section, and
two or more of the plurality of conductive films are arranged discretely at a first region having the signal line driving circuit or wiring that is connected with the signal line driving circuit on the peripheral section.

6. The liquid crystal display according to claim 5, wherein other conductive films among the plurality of conductive films are provided along an end edge of the alignment film at another second region of the peripheral section.

7. The liquid crystal display according to claim 6, wherein a planar shape of the alignment film is rectangular, and
the first region is a region corresponding to one side of the rectangular form, while the second region is a region corresponding to three sides and four corners of the rectangular form.

8. The liquid crystal display according to claim 4, wherein a planar shape of the alignment film is rectangular, and
the plurality of conductive films are provided at regions corresponding to four corners of the rectangular form.

9. The liquid crystal display according to claim 8, wherein the plurality of conductive films are provided at a region corresponding to four corners and three sides of the rectangular form.

10. The liquid crystal display according to claim 3, wherein a planar shape of the alignment film is rectangular, and
the conductive film is provided along an end edge of the alignment film at a region corresponding to four sides of the rectangular form.

11. The liquid crystal display according to claim 1, wherein the protective film is selectively formed at the pixel section on the drive substrate.

12. The liquid crystal display according to claim 1, wherein the alignment film is an inorganic alignment film, and
the protective film is an inorganic film that is more chemically-stabilized than the alignment film.

13. The liquid crystal display according to claim 12, wherein the alignment film is formed in an evaporation method, and the protective film is formed in a chemical vapor deposition method.

14. The liquid crystal display according to claim 13, wherein the alignment film is a silicon oxide film, and the protective film is a silicon oxide film or a silicon nitride film.

15. The liquid crystal display according to claim 1, wherein the conductive film is configured of the same transparent conductive film as the pixel electrode.

16. The liquid crystal display according to claim 15, wherein the pixel electrode and the conductive film are configured of indium tin oxide.

17. The liquid crystal display according to claim 1, wherein the conductive film functions as a part of a wiring layer that is provided on the drive substrate.
